(19) United States
(12) Patent Application Publication
(10) Pub. No.: US 2010/0139522 A1
(43) Pub. Date: Jun. 10, 2010

(54) MIXTURE AND METHOD FOR PRESERVING POROUS MATERIALS

(76) Inventor: Wolf Hermann Ibach, Schesslitz (DE)

Correspondence Address: Oliver Intellectual Property LLC, P.O. Box 1670, Cotuit, MA, 02635, US

(21) Appl. No.: 12/665,976

(22) PCT Filed: Jun. 20, 2008
(86) PCT No.: PCT/EP08/04968

§ 371 Date: Dec. 22, 2009

(30) Foreign Application Priority Data
Jul. 2, 2007 (DE) 10 2007 030 672.7

(51) Int. Cl. C09D 5/00

(52) U.S. Cl. 106/12

(57) ABSTRACT

The invention relates to a liquid substance mixture for conserving porous materials, in particular objects made of stone or wood, the mixture containing at least two substances from the group of the organically modified silicon dioxides, in particular organo(alkoxy)silanes (ormosils). The invention further relates to a method for conserving porous materials.

### CROSS-REFERENCE TO RELATED APPLICATIONS

This application is a section 371 of PCT/EP08/04968, filed Jun. 20 2008, published Jan. 8, 2009 as WO 2009-003594-A, and further claims priority to German application DE 10 2007 030 672.7 filed Jul. 2, 2007, the entire content of which is hereby incorporated by reference.

### FIELD OF THE INVENTION

The invention relates to a methyl methacrylate-free substance mixture for conserving porous materials, in particular objects made of stone or wood. The invention further relates to a method for conserving porous materials.

### BACKGROUND

Conservation and weather protection of previously weathered natural stone often proceeds on the principle of protecting and consolidating the surface of the stone (i.e. the visible areas) by delivering protective substances. Any delivery of protective substances, however, results in a change in the physical properties of the stone in those areas that are reached. That change in physical properties is often associated with consequential damage. The goal of any conservation action should therefore be to minimize that change, and to bring about conservation over the entire cross section of the stone (i.e. all the way to the core), in order to eliminate zones having different physical properties.

This requirement is implemented in its essential points by the complete acrylic resin impregnation method, developed since 1972, in which the stone, previously completely dried, is impregnated to the core with methyl methacrylate (MMA) in an immersion bath, with the aid of vacuum and pressure, and the MMA is then polymerized to acrylic glass. Because this method causes curing of the entire impregnation solution, the pores are completely filled with PMMA, so that water uptake and air permeability are completely suppressed.

For many years, it has been desirable in historic preservation to have an open-pore conservation method in which the protective effect and consolidating effect are achieved by means of a protective film in the interior of the pore system, i.e. by lining the pore walls. This objective of lining the pore walls is not achieved with the use (tolerated in historic preservation) of tetraethoxysilane (TEOS), better known by the term “silicic acid ester,” whose “end product” after the reaction has proceeded is silica gel made up of pure SiO₂. This gel becomes fragile and cracked when completely reacted by hydrolysis and polycondensation, and the resulting SiO₂ exists in the pore space in the form of faulted blocks. The protective and consolidating effect is therefore often poor, and furthermore an additional micropore system is generated so that behavior in terms of water uptake and water output is uncontrollably influenced. Attempts to modify this silica-gel formation process so as to produce a sufficiently elastic, film-forming gel have been unsuccessful. The only systems suitable for coating internal surfaces are those that are made up of monomers and are thus capable of getting into even very small pores. Paint-type systems in the form of monomer/polymer systems (nanosystems proven for external use) fall short, especially for stonework, because of their insufficient ability to penetrate into many pore systems.

### SUMMARY OF THE INVENTION

The object of the invention is to generate, in the context of porous materials and in particular objects, a protective layer in the pore system that is resistant to the attack of water and pollutants, and at the same time to build up binding agent that is absent from the pore system.

This object is achieved according to the present invention in that the mixture contains at least two substances from the group of the organically modified silicon dioxides, in particular organo(alkoxy)silanes (ormosils).

It has been found, surprisingly, that different combinations of organo(alkoxy)silanes (also called “ormosils” i.e. organically modified silicas) are suitable for such coating of internal surfaces. In contrast to the nanosystems and the “paint” systems made up of solvent and solids, the substance mixtures have very good penetration behavior because of their molecule size, and are capable of getting into even very small pores.

Once the internal cavities have been reached, these substance mixtures cure by hydrolysis and polycondensation, so that a solids content of between 4% and 69%, in particular between 8% and 30%, remains behind in the pore space as a film that lines the pore walls.

The curing operation that proceeds by hydrolysis and polycondensation can be controlled surprisingly well, especially in the case of large-volume objects, by program-controlled temperature and moisture delivery.

Experiments have shown that, surprisingly, a corresponding water component can be added in order to initiate hydrolysis while maintaining for a sufficient time the good penetration behavior for highly absorbent porous materials.

The silica gel produced in the pore space demonstrably coats the pore walls as a crack-free, transparent, water-insoluble film with good adhesion, so that the hoped-for pore lining effect does occur.

Surprisingly, the necessary water can be delivered shortly before impregnation without influencing, in more strongly negative fashion, the penetration behavior during the necessary penetration time.

It is particularly advantageous to add 1 to 10% of an adhesion primer, in particular an organosilane. It is also significant that a liquid, acrylate-free substance mixture is achieved.

Advantageous embodiments of the invention are set forth below.

### DETAILED DESCRIPTION

Exemplifying embodiments of the invention are described below in further detail.

The liquid substance mixture according to the present invention is used for conservation impregnation of porous materials, in particular of objects made of wood or stone.

The two components of the active-substance system, made up of glycidyloxypropyltrimethoxysilane (GLYMO) and aminopropyltriethoxysilane (APTS) in alcohol solution, are combined in stoichiometric quantities prior to injection into the pore system of the material to be conserved, and react (releasing water) to yield an intermediate product having six peripheral alkoxy groups. The active-substance system is activated by partial hydrolysis, and condenses (releasing water and alcohol) to yield a silica gel into whose structure the organic components are incorporated between Si atoms, contributing more or less as spacers to the construction of a low-stress gel structure (illustration).

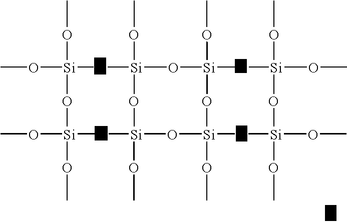

The conserving liquid can be of differing composition, the mixture containing at least one substance from the group of the organo(alkoxy)silanes (ormosils).

The following mixtures are particularly advantageous in this context:
a) One substance of the mixture is an ormosil that contains at least one epoxy unit.
b) One substance of the mixture is a 3-glycidyloxypropyltrimethoxysilane (GLYMO).
c) One substance of the mixture is an ormosil that contains at least one amine function.
d) One substance of this mixture is a gamma-aminopropyltriethoxysilane (APTS).
e) Two substances of this mixture are made up of the ormosils characterized above under a) and c).
f) Two substances of this mixture are made up of the ormosils characterized above under b) and d).

Alcohol having one to six carbon atoms, in particular ethanol or methanol, is preferably added as a hydrophilic solvent.

The mass ratio of the ormosil that contains at least one epoxy unit to the ormosil that contains at least one amine function is 1:0.2 to 1:10, by preference 1:0.7 to 1:1.7, and in particular a mass ratio of 1:1.07.

A further alternative is that in addition to the ormosil that comprises at least one epoxy unit, and in addition to the ormosil that contains at least one amine function, at least one further ormosil is also contained. The further ormosil is, in this context

a gamma-methacryloxypropyltrimethoxysilane,

a vinyltriethoxysilane,

a dimethyldiethoxysilane, and/or

a dimethyldimethoxysilane.

It is significant that a corresponding water component is added to the mixture in order to initiate hydrolysis.

### FURTHER EXAMPLE

The porous material in the form of an object, e.g. a stone or a piece of wood, is first dried and then dipped into a liquid that is made up of at least two ormosils plus a solvent liquid, by preference ethanol. The weight ratio of the ormosil that contains at least one epoxy unit to the ormosil that contains at least one amine function is 1:1.07. An advantageous mixture is made up of 2.4 g ormosil 1,2.3 g ormosil 2, and 28 g ethanol. With 28 g ethanol, a solids deposition in the object of approx. 9.5 to approx. 10% is achieved. The ethanol component selected can be, in this context, between 0 and 50 g.

This method results in not only greater weathering resistance but also higher strength for the object. This is apparent from a considerable elevation in modulus of elasticity.

It will be apparent, to those having ordinary skill in the material conservation art, that various modifications are possible within the scope of the present invention. Therefore, the invention is not limited to the specific examples set forth above, but rather is defined by the following claims.

What is claimed is:

1. A methyl methacrylate-free liquid substance mixture for conserving porous materials, wherein
the mixture contains at least two substances from the group of the organically modified silicon dioxides (ormosils).

2. The substance mixture according to claim 1, wherein
one substance of the mixture is an ormosil that contains at least one epoxy unit.

3. The substance mixture according to claim 1, wherein
one substance of the mixture is a 3-glycidyloxypropyltrimethoxysilane (GLYMO).

4. The substance mixture according to claim 2, wherein
one substance of the mixture is an ormosil that contains at least one amine function.

5. The substance mixture according to claim 1, wherein
one substance of said mixture is a gamma-aminopropyltriethoxysilane (APTS).

6. The substance mixture according to claim 1, characterized by the addition of an alcohol having one to six carbon atoms, serving as a hydrophilic solvent.

7. The substance mixture according to claim 6, wherein
the alcohol is selected from the group consisting of ethanol and methanol.

8. The substance mixture according to claim 4, wherein
the mass ratio, of
the ormosil that contains at least one epoxy unit to
the ormosil that contains at least one amine function,
is 1:0.2 to 1:10.

9. The substance mixture according to claim 4, wherein
in addition to the ormosil that comprises at least one epoxy unit, and in addition to the ormosil that contains at least one amine function, at least one further ormosil is also contained.

10. The substance mixture according to claim 9, wherein
the further ormosil added to the mixture is a gamma-methacryloxypropyltrimethoxysilane.

11. The substance mixture according to claim 9, wherein
the further ormosil added to the mixture is a vinyltriethoxysilane.

12. The substance mixture according to claim 9, wherein
the further ormosil added to the mixture is a dimethyldiethoxysilane.

13. The substance mixture according to claim 9, wherein
the further ormosil introduced into the mixture is a dimethyldimethoxysilane.

14. The substance mixture according to claim 1, wherein
a corresponding water component is added to the mixture in order to initiate hydrolysis.

15. A method of conserving porous materials using a mixture consisting essentially of two substances selected from the group of organically modified silicon dioxides (ormosils) comprising the steps of
impregnating the porous material with said mixture of ormosils and
subsequently drying the porous material.

16. The method of claim 15, wherein said impregnating step comprises impregnating with a mixture consisting essentially of two substances selected from the group of organo(alkoxy)silanes.

17. The substance mixture according to claim 1, wherein
the mixture consists essentially of two substances selected from the group of organo(alkoxy)silanes.

18. The substance mixture according to claim 4, wherein the mass ratio, of
the ormosil that contains at least one epoxy unit to
the ormosil that contains at least one amine function,
falls within a mass ratio range from 0.7 to 1 : 1.7.

19. The substance mixture according to claim 4, wherein the mass ratio, of
the ormosil that contains at least one epoxy unit to
the ormosil that contains at least one amine function,
is about 1:1.07.

20. The substance mixture according to claim 2, wherein
one substance of the mixture is a 3-glycidyloxypropyltrimethoxysilane (GLYMO).
